(19) United States
(12) Patent Application Publication
(10) Pub. No.: US 2014/0267342 A1
(43) Pub. Date: Sep. 18, 2014

(54) METHOD OF CREATING REALISTIC AND COMIC AVATARS FROM PHOTOGRAPHS

(71) Applicant: Victor Liu, Belvedere-Tiburon, CA (US)

(72) Inventor: Victor Liu, Belvedere-Tiburon, CA (US)

(21) Appl. No.: 14/209,846

(22) Filed: Mar. 13, 2014

Related U.S. Application Data
(60) Provisional application No. 61/780,675, filed on Mar. 13, 2013.

(51) Int. Cl. G06T 11/00; G06T 11/60

(52) U.S. Cl. CPC G06T 11/001; G06T 11/60
USPC 345/581

(57) ABSTRACT

A method of creating an avatar for use as an online visual representative, which includes the steps of selecting and opening a digital file of an original portrait facial photograph in a photo editing program; transforming the original portrait facial photograph into a realistic avatar image by modifying select areas of the photograph, including the eyes, nose, face shape, and mouth; and transforming the realistic avatar produced into a comic avatar by further modifying features of the facial image, the modifications including, changing skin color, changing eye size and shape, changing nose size and shape, changing hair color, and changing facial shape and proportion.

### CROSS REFERENCES TO RELATED APPLICATIONS

The present application claims the benefit of the filing date of U.S. Provisional Patent Application Ser. No. 61,780,675, filed Mar. 13, 2013 (Mar. 13, 2013).

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND OF THE INVENTION

1. Field of the Invention

The present invention relates generally to methods of creating a graphical representation of a user's character for use as an avatar, and more particularly to an avatar creation method for creating both a realistic and a comic avatar of a user based on the user's portrait photograph.

2. Background Discussion

Various methods are known for creating on-screen user representations, or avatars. They are most often employed for use in video games, on-line role playing games, virtual worlds, on-line forums, blogs, chat rooms, and instant messaging. Some of the more interesting methods are described in the following patents:

U.S. Pat. No. 7,006,098 to Bickmore, discloses a method and system for creating autonomous personal avatars for attachment to electronic documents. The avatars change behavior based on the reader's actions and the context within the document. The avatars also interact with the document itself.

U.S. Pat. No. 7,184,047 to Crampton, teaches an apparatus for generating an avatar that includes a photo booth connected to a server through the Internet, wherein image data of an individual is captured using the booth, and a computer model corresponding to the individual is then generated by comparing the captured image data relative to a stored generic model. Data representative of a generated model is then transmitted to the server, and the stored data can then be retrieved via the Internet using a personal computer with software that uses the data to create graphic representations of an individual in any one of a number of poses.

U.S. Pat. No. 8,077,179, to Ludwigsen, describes a system for “cartoonizing” an image and incorporating it into an animated video. The method involves using a cartoonizing program to cartoonize the image and generate a cartoonized output, and then using an animation application to incorporate the cartoonized output into an animated video. The image is obtained from a photograph or other two-dimensional depiction of a subject. The cartoonizing involves using an application with at least one graphics editing option to select a portion of the photograph or other two-dimensional depiction of a subject to be cartoonized, adjusting the size of the image, and displaying the cartoonized output.

U.S. Pat. No. 8,146,005, to Jones, discloses a capture system for capturing attributes of a user, comparing the detectable attributes with a normalized model of attributes to characterize normal representative attribute values across a sample of a plurality of users and generate differential attributes representing the differences between the detectable attributes and the normalized model of attributes, and using multiple separate avatar creator systems to receive the differential attributes and with each to apply the differential attributes to different base avatars to create custom avatars reflecting a selection of the detectable attributes of the user which are distinguishable from the normalized model of attributes.

U.S. Pat. Appl. Ser. No. 2002/0067362 by Nocera et al, teaches a method for generating an avatar animation transform using a neutral face image, including the steps of providing a neutral-face front head image and a side head image for generating an avatar and automatically finding head feature locations on the front head image and the side head image using elastic bunch graph matching; positioning nodes automatically at feature locations on the front head image and the side head image; and manually reviewing the node positions and correcting them to remove artifacts and minimize distorted features in the avatar generated based on the node positions.

On-line avatar creation services have proliferated in recent years. By way of example only, some exemplary systems include DoppelMe at http://doppelme.com/, where users create cartoon characters to represent themselves as avatars. Another can be found at Create Avatar at www.southparkstudios.com. Still another is found at www.marvel.com, which provides tools to create superhero avatars. Unique, by Raster Boy, is a tool for creating full body cartoon avatars. FaceYourManga.com features a way to make what the company refers to as “mangatars,” feature by feature using option palettes. Voki.com provides a tool to create animated and speaking avatars that can use the creator's own voice. These are but a few of numerous sites that offer avatar creation tools. None, however, provide means to create an avatar from a personal photograph using a set of tools that allow modification of the photograph to enhance, distort, caricature, and otherwise stylize features for effect.

The foregoing patents and on-line commercial avatar creation services reflect the current state of the art of which the present inventor is aware. Reference to, and discussion of, these patents and other background art is intended to aid in discharging Applicant's acknowledged duty of candor in disclosing information that may be relevant to the examination of claims to the present invention. However, it is respectfully submitted that none of the above-indicated patents disclose, teach, suggest, show, or otherwise render obvious, either singly or when considered in combination, the invention described and claimed herein. Specifically, none involve a systematic program of method steps for importing and then modifying a portrait, or partial or full body photo, to render first a realistic avatar that may be used as a representative character in digital forums, or that may be further modified to “cartoonize” the realistic avatar.

### SUMMARY OF THE INVENTION

The avatar creation tool of the present invention is a software application for use as an artistic instrument on any standalone or network-connected device, including a personal computer, an Apple Macintosh computer, a tablet, a laptop, a smartphone, and the like. The method proceeds in two phases, the first phase for importing and modifying a portrait-style photograph into a stylized (improved) personal image for use as a realistic avatar; the second, an optional phase, is for further modifying the realistic avatar image to transform the realistic avatar into a cartoon image.

The foregoing summary broadly sets out the more important features of the present invention so that the detailed description that follows may be better understood, and so that the present contributions to the art may be better appreciated. There are additional features of the invention that will be described in the detailed description of the preferred embodiment of the invention which will form the subject matter of the claims appended hereto.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1A is block diagrammatic flow chart showing the essential steps of the realistic and comic avatar creation system of the present invention;

FIG. 1B (comprising FIG. 1B-1 and FIG. 1B-2) is a block diagrammatic flow diagram showing details of the steps shown in FIG. 1A, with FIG. 1B-1 showing a portion of the steps shown in FIG. 1A relating to the method of transforming a photograph to a human-like (“realistic”) avatar, and FIG. 1B-2 showing the steps taken to complete the transformation of a photograph into a realistic avatar, and then transforming the realistic avatar into a comic avatar; and

FIG. 2 is a highly schematic image of a photograph showing zones or areas of the user's face available for modification to create effects.

### DETAILED DESCRIPTION OF THE INVENTION

Turning first to FIG. 1, there is shown in highly schematic block diagrammatic form a method of creating a realistic avatar from a photograph or other representative digital image. The method is generally denominated 10 herein. FIG. 2 shows the touch up zones or regions in a digital photograph 40 of a user's head and face 42 that, in a preferred embodiment, can be modified using the avatar creation tools provided in the present invention. These include the eyes 44, the nose 46, the mouth 48, and the overall face shape 50.

Using the method steps of the present invention, an avatar can be created that is an ideal image of oneself. Using a library of attributes, physical features, and characteristics that are universally agreed upon as desirable in a human face, one can create an ideal representative of oneself having, for instance, a more chiseled face with larger and more sparkling eyes with and longer eye lashes, finer eyebrows, a more proportional and better shaped nose, more voluptuous lips, whiter teeth, fuller hair, and more radiant skin. Facility with the inventive method enables an experienced artist to create an avatar that resembles the real person, retaining all the truly distinctive and distinguishing features of the subject, but modified in the avatar creation process to include improvements on nearly all the features independently and in combination. Yet, with the inventive process, even an inexperienced amateur artist can create an impressive avatar. The method steps are set out below.

In the following description, the exemplary method steps involve use of still portrait photograph of a human stored in digital form for manipulation using image editing software. The illustrated avatar was created in two-dimensional stationary form. It can naturally be extended to three-dimensional and/or animated form. In animated form, the avatar can be made to speak using a software program such as ‘CrazyTalk Animator’.

The software selected for describing the method steps of the present invention is Adobe Photoshop CS6. The features and tools of this program are described in detail in any of a number of publications relating to the software, including the Photoshop CS5 & CS6 Manual, and more preferably the book entitled, Adobe Photoshop CS6 Classroom in a Book, © 2012 Adobe Systems Incorporated, ISBN-13: 978-0-321-82733-3, published by Adobe Press, San Jose, Calif., which book is incorporated in its entirety by reference herein. However, it will be appreciated that the tools, elements, functions, and features provided by Adobe Photoshop CS6 are also provided by a number of high level image editing and graphic art and graphic editing programs, including Corel PAINTSHOP Pro X5, Adobe Photoshop Elements, Serif PhotoPlus, Xara Photo & Graphic Designer, ACDSee Photo Editor, Photo Impression, and Photolightning. Accordingly, while the method steps employ terminology and nomenclature specific to Adobe Photoshop, it will be understood that the disclosure includes the steps to the extent that they can also be performed using any of the foregoing and many other photo editing software programs.

Further, while the description that follows is directed principally to a digital representation of a portrait photograph of a face, the method can be extended quite naturally to the whole body. Further still, the same method can be used to generate avatars for animals and objects. The method assumes use of an electronic data device having a core processor, a permanent memory for storing a computer-executable program, temporary memory or functional equivalents for loading and running a program, program loading means, an electronic visual display and a display subsystem, and at least one user input device for interacting with the executable program. Any of a number of network-connected and standalone computing devices may be suitable, including personal computers, Apple Macintosh computers, table computers, laptop computers, handheld multimedia devices, and smartphones.

Referring now to FIGS. 1A and 1B, the inventive method includes two primary stages 10a, 10b. In a first stage 10a, a photograph is transformed from a raw photograph to a pseudo-photorealistic, human-like (“realistic”) avatar; and in a second stage 10b, the realistic avatar is transformed into a comic avatar. It will be understood that many of the steps set out below are purely optional and may be bypassed, either directly or by taking no action during that particular phase of the avatar creation process.

The first stage includes opening an image file containing an original input photo 12. In this instance, the photograph is opened in Adobe Photoshop 12a. At ‘View’ and ‘Snap’ the ‘none’ option is selected 12b so as to enable free form movement of any image object or element.

The next step is to align the photograph 14 so that select elements in the view are brought into a more pleasing orientation. This is done by creating a new layer 14a called ‘New Background.’ The ‘lasso tool’ is employed to copy 14b the whole image from ‘Background’ and then to paste it 14c in Layer ‘New Background.’ The image is next rotated 14d in ‘New Background’ until the eyes, nose, lips are aligned horizontally. Finally, the image is duplicated 14e in ‘New Background’ called ‘Skin.’ This becomes the working layer.

The next step is to rejuvenate the image 16 by using the ‘spot healing tool’ to smooth the skin 16a in Layer ‘Skin.’ The ‘color replacement tool’ is then used to whiten teeth and refresh the lips 16b.

Next, the nose area is addressed 18. The ‘lasso tool’ is selected to copy the nose area 18a and paste it 18b into a new layer called ‘Nose.’ Next, select ‘transform’ and then ‘perspective’ to reduce ‘Nose’ 18b width with a new width, e.g., 90%. It may be necessary to move the area slightly to make the face proportional 18c. Then ‘eraser’ is used to smooth the transition 18d, as necessary.

Next, the right eye area is addressed 20. Then ‘lasso tool’ is selected to copy the right eye area 20a, including the eyebrow and then paste it 20b to a new layer called ‘Right Eye Area.’ As before, ‘transform’ is selected and then ‘perspective’ to enlarge the ‘Right Eye Area’ 20c with new width, e.g., 120% and a new height, e.g., 120%. The steps to this point put the face into a pleasing upright position, and change the relative proportions of the nose and eyes. Once the right eye is sized, it may also be necessary to move the area 20d slightly to make the face more pleasingly proportional. The ‘eraser’ tool is used to smooth the transition 20e, as necessary. The ‘lasso tool’ is employed to copy the right eye 20f and to paste it 20g to a new layer preferably called ‘Right Eye.’ Then ‘transform’ and ‘perspective’ are employed to enlarge ‘Right Eye’ height 20h with new height, e.g., 110%. ‘Eraser’ is used to smooth the transition 20i, as necessary. Again, ‘lasso tool’ is to copy the right pupil 20j and to paste it 20k to a new layer called ‘Right Pupil.’ Next, ‘transform’ and ‘perspective’ are employed to enlarge ‘Right Pupil’ width 201 with a new width, e.g., 120%. ‘Eraser’ is used then to smooth the transition 20m, as necessary.

In the next step 22, the left eye area is addressed. The ‘lasso tool’ is employed to copy the left eye area 22a including the eyebrow, after which it is pasted 22b to a new layer, conveniently and preferably called ‘Left Eye Area.’ Transform' and ‘perspective’ are employed to enlarge left Eye Area' 22c with a new width, e.g., 120% and a new height, e.g., 120%. It may be necessary to move the area slightly 22d to make the face more pleasingly proportional. The ‘eraser’ may then be used to smooth the transition 22e, as necessary. The ‘lasso tool’ is then used to copy the right eye 22f and to paste it 22g to a new layer, preferably called ‘Left Eye.’ ‘Transform’ and ‘perspective’ may then be used to enlarge ‘Left Eye’ height 22h with a new height, e.g., 110%. ‘Eraser’ may be used to smooth the transition 22i, as necessary. Then the ‘lasso tool’ is used to copy the left pupil 22j and to paste it 22k to a new layer, preferably called ‘Left Pupil.’ Transform' and ‘perspective’ may then be employed to enlarge ‘Left Pupil’ width 221 with new width, e.g., 120%. ‘Eraser’ can be used to smooth the transition 22m, as necessary.

At this point a realistic avatar is generated 24. The ‘spot healing’ tool may be used at this point to smooth the skin 24a where necessary.

In the second stage of processing 100, the realistic avatar is transformed into a comic avatar. The stage first entails importing or opening the file for the realistic avatar 26 created in stage 1. The next step involves creating a comic avatar outline 28, by first creating a layer 28a preferably called ‘Outline,’ and selecting the ‘pen tool’ to choose a dark color with which to trace or draw an outline 28b of the realistic avatar face and/or figure. ‘Eraser’ can be used to clean 28c any mistakes. It may be desirable to trace and draw only the tip of the nose 28d without the nares to render the figure slightly more comic in appearance. Additionally, the teeth may be moved up 28e if any gum is showing in a smile, as gum is usually not drawn in comics.

The skin is next simulated 30. A layer called ‘Skin’ is created 30a. The ‘eyedropper tool’ is employed to pick a suitable skin color 30b from the realistic avatar, and the skin is colored 30c accordingly. If desired, the skin may be shaded 30d with a darker skin color on the same ‘Skin’ layer, and a layer is then created 30e and called ‘Skin Shade.’ The ‘Skin Shade’ layer is made to be of the ‘Overlay’ type and the same skin color is selected 30e. The skin shade is then colored in 30f.

In the next step and sub-steps 32, the hair, eyebrow, and eyes are addressed. A layer called ‘Hair and Eyebrow’ is created 32a and colored 32b using any comic hair and eyebrow colors desired. An ‘Eye’ layer is created 32c and the pupils and the scleras are colored 32d. Preferably, reflection dots are added to the pupils 32e to make them sparkle. Then an ‘Eye Shade’ layer is created 32f to shade the eyes. This layer is set up to be of the type ‘Multiply’ 32g, and the sclerae are then shaded with grey 32h while the pupils are shaded with a color darker than the subject pupils 32i.

Attention next moves to the lips and teeth 34. A layer called ‘Mouth’ is created 34a, and the lips are colored with a lip color 34b. Reflection dots may be added to the lower lip to give it enhanced sparkle 34c. The teeth are then whitened 34d or changed to another color 34e.

In the final step, the ‘color replacement tool’ is selected 36 so that the resulting comic avatar 38 created with the foregoing steps can be customized to take on different colors, and there is thus produced a comic avatar that may be any of a number of different colors.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. A method of creating an avatar, comprising the steps of:
(a) providing an electronic data device having a core processor, a permanent memory for storing a computer-executable program, temporary memory or functional equivalents for loading and running a program, program loading means, an electronic visual display, a display subsystem, at least one user input device for interacting with an executable program
(b) loading the avatar creation program on the electronic data device, the avatar creation program enabling the user to interact with the electronic data device to edit an image file;
(c) opening an image file containing an original input photo of a person; and
(d) modifying selected areas and features of the input photo to create a realistic avatar.

2. The method of claim 1, further including the step of cartoonizing the realistic avatar to create a comic avatar based on the original input photo.

3. The method of claim 2, wherein the step of cartoonizing the realistic avatar includes one or more substeps selected from the group consisting of: outlining the face of the realistic avatar, tracing the nose, coloring the skin with a preselected shade, coloring the hair and eyebrows with a preselected shade, coloring the pupils and sclera of the eyes, adding sparkle to the eyes, coloring the lips, enhancing the lips with sparkle, and whitening the teeth.

4. The method of claim 3, further including the step of replacing one or more color choices.

5. The method of claim 1, wherein the step (d) step of modifying selected areas and features of the input photo to create a realistic avatar includes one or more substeps selected from the group consisting of: opening an image file in an image editing program; enabling free form movement of the image; aligning the image; rotating the image to align the eyes, nose, and lips; smoothing the skin; whitening the teeth; refreshing the lips; altering nose dimensions; making the face proportional to the altered nose dimensions; copy each eye area, including the eyebrows, and resizing the eyes and the pupils; smoothing transitions in areas modified; saving in an image file a copy of the realistic avatar generated.

6. The method of claim 5, further including the step of cartoonizing the realistic avatar to create a comic avatar based on the original input photo, said cartoonizing step including one or more substeps selected from the group consisting of: outlining the face of the realistic avatar, tracing the nose, coloring the skin with a preselected shade, coloring the hair and eyebrows with a preselected shade, coloring the pupils and sclera of the eyes, adding sparkle to the eyes, coloring the lips, enhancing the lips with sparkle, and whitening the teeth.

7. A method of creating a digital avatar, comprising:
(a) loading an image editing program on an electronic data device having means for a user to interact with the image editing program to edit a digital image file;
(b) opening in the image editing program an image file containing an original input photo of a person; and
(c) modifying selected areas and features of the original input photo to transform the original input photo in a human-like realistic avatar.

8. The method of claim 7, further including the step of modifying the realistic avatar to create a comic avatar.

9. The method of claim 8, wherein the step of transforming the realistic avatar to create a comic avatar comprises the following steps, singly or in any combination thereof: outlining the face of the realistic avatar using a dark color, tracing all or a portion of the nose, selecting a shade and coloring the skin with the selected shade, selecting a color and then coloring the hair and eyebrows with the selected color, selecting a color or colors and then coloring the pupils and sclerae of the eyes with the selected colors, adding reflecting dots to the eyes, selecting a color and then coloring the lips with the selected color, enhancing the lips with sparkle, and whitening the teeth.

10. The method of claim 9, wherein step (c) comprises the following substeps, singly or in any combination thereof: opening an image file in an image editing program; enabling free form movement of the image; aligning the image; rotating the image to align the eyes, nose, and lips; smoothing the skin; whitening the teeth; refreshing the lips; altering nose dimensions; making the face proportional to the altered nose dimensions; copy each eye area, including the eyebrows, and resizing the eyes and the pupils; smoothing transitions in areas modified; saving in an image file a copy of the realistic avatar generated.

11. The method of claim 7, wherein step (c) comprises the following substeps, singly or in any combination thereof: opening an image file in an image editing program; enabling free form movement of the image; aligning the image; rotating the image to align the eyes, nose, and lips; smoothing the skin; whitening the teeth; refreshing the lips; altering nose dimensions; making the face proportional to the altered nose dimensions; copy each eye area, including the eyebrows, and resizing the eyes and the pupils; smoothing transitions in areas modified; saving in an image file a copy of the realistic avatar generated

12. A method of creating an avatar for use as an online visual representative, comprising the steps of:
(a) selecting and opening a digital file of an original portrait facial photograph in a photo editing program;
(b) transforming the original portrait facial photograph into a realistic avatar image by modifying select areas of the photograph, including the eyes, nose, face shape, and mouth; and
(c) transforming the realistic avatar produced in step (b) into a comic avatar by further modifying features of the facial image, the modifications including, changing skin color, changing eye size and shape, changing nose size and shape, changing hair color, and changing facial shape and proportion.
